(19) United States
(12) Patent Application Publication
(10) Pub. No.: US 2020/0226895 A1
(43) Pub. Date: Jul. 16, 2020

(54) ACOUSTIC TAMPER DETECTION FOR METAL STRUCTURES

(71) Applicant: Schweitzer Engineering Laboratories, Inc., Pullman, WA (US)

(72) Inventor: George W. Masters, Moscow, ID (US)

(73) Assignee: Schweitzer Engineering Laboratories, Inc., Pullman, WA (US)

(21) Appl. No.: 16/249,036

(22) Filed: Jan. 16, 2019

(51) Int. Cl. G08B 13/16; G01H 1/00; H02J 13/00

(52) U.S. Cl. CPC G08B 13/1672; H02J 13/0017; G01H 1/00

(57) ABSTRACT

Metallic structures having acoustic-based tamper detection sensors are disclosed. The acoustic-based tamper detection sensors may have contact microphones in direct contact with the metallic structures. Upon detection of tamper based on acoustic signals, the tamper detection sensors may broadcast a tamper warning signal or data and/or store the tamper warning data in a memory.

### FIELD OF DISCLOSURE

The present disclosure relates generally to protection of metal structures. More specifically, embodiments of the present disclosure relate to systems and methods that can be used to detect tampering using acoustic signals.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Power distribution networks transport electricity from power plants or power stations to electricity consumers, such as residences, commercial locations, or manufacturing plants. Power distribution networks may include power transmission grids or power distribution grids to connect geographically separated consumers and suppliers. To that end, the transmission grids or distribution grids may include transmission lines, transformer stations, or other structures located in remote areas. Owing to the remote location and related challenges in monitoring, these structures may be vulnerable to threats, such as theft or vandalism.

### BRIEF DESCRIPTION

Certain examples commensurate in scope with the originally claimed subject matter are discussed below. These examples are not intended to limit the scope of the disclosure. Indeed, the present disclosure may encompass a variety of forms that may be similar to or different from the examples set forth below.

In accordance with an example, an acoustic sensor for a metallic structure includes a contact microphone, filtering circuitry, and radiofrequency circuitry. The contact microphone is arranged to be placed in direct contact with the metallic structure being monitored. The filtering circuitry may receive a signal from the microphone, filter the signal by amplifying components of the signal associated with the perturbations to the metallic structure, and generate a warning signal based on the filtered signal. The radiofrequency circuitry can transmit a radiofrequency signal based on the warning signal to a neighboring repeater, a neighboring acoustic sensor, or a neighboring electrical facility.

In accordance with another example, a transmission line includes a metallic structure having an acoustic sensor. The acoustic sensor may have a contact microphone in direct contact with the corresponding metallic structure. The acoustic sensor includes filtering circuitry that may receive a signal from the contact microphone, filter the received signal by attenuating components of the received not associated with the perturbation, and generating a warning signal from the filtered signal. The acoustic sensor may also include a radiofrequency transmitter capable of broadcasting a radiofrequency signal based on the warning signal to an autonomous vehicle, a neighboring repeater, a neighboring acoustic sensor, or a neighboring electrical facility.

In accordance with another example, a method to monitor of transmission line may include detecting a tamper to a metallic structure of the transmission line using an acoustic sensor having a contact microphone in contact with the metallic structure. The method may also include sending a tamper warning signal when a tamper to a metallic structure is detected upon polling by an autonomous polling device, which may report the tamper warning to a home base.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of a transmission line having metallic structures that may benefit from the acoustic tamper detection system, in accordance with an embodiment of the present disclosure;

FIG. 2 is a diagram of an acoustic tamper detection system that may detect tampering in a metallic structure, in accordance with an embodiment of the present disclosure;

FIG. 3 is a flow chart for operation of an acoustic tamper detection system to detect tampering in a metallic structure, in accordance with an embodiment of the present disclosure;

FIG. 4 is a flow chart for operation of an autonomous polling device to monitor a transmission line, in accordance with an embodiment of the present disclosure; and

FIG. 5 is a flow chart of a method to broadcast tamper warning signals in a transmission line, in accordance with an embodiment.

### DETAILED DESCRIPTION

One or more specific embodiments of the present disclosure will be described below. In an effort to provide a concise description of these embodiments, not all features of an actual implementation may be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

Power distribution networks may include power transmission lines for connecting suppliers and consumers of electricity in geographically distant areas. Owing to the geographical separation, the transmission lines may cross remote regions, which may be located at various distances away from manned facilities. Certain structures of the power transmission lines do not receive regular maintenance under regular conditions. Instead, these transmission lines may go through long periods without being manually inspected.

The absence of continuous monitoring and the remoteness of these metallic structures may make them particularly vulnerable to vandalism, theft, sabotage, or other types of tampering. Such tampering, while initially undetected, may lead to losses in the long term if there is no adequate repair to undo any damage. For example, if a person dislodges a part of the metallic structure or cuts a supporting wire (e.g., a guy wire) in a manner that does not immediately disrupt the power transmission, the tampering could go undetected. However, such tampering may affect the structural soundness of the metallic structure, leading to a disruption in the power transmission during a storm with strong winds or other damage-inducing event.

Accordingly, disclosed herein are systems and methods for monitoring the tampering of structures in a power transmission line. The methods and systems may use strategies based on acoustic identification of potential damages to the structure, and strategies to broadcast the information using low power. To that end, metallic structures in a transmission lines may have acoustic tamper sensors (i.e., tamper sensors that process acoustic signals) to detect tampering of the metallic structure. The acoustic tamper sensors may, in turn, generate warning signals upon detection of the tampering. The warning signals may be transmitted to other structures in the transmission line by, for example, the transmission of a radiofrequency signal (e.g., radio communications at cellular frequencies, ultra-high frequencies (UHF), very high frequencies (VHF)), a visual indication (e.g., a light source, a color-coded light source, a blinking light source, a mechanically triggered visual panel), or a signal traveling through a cable system (e.g., a telegraphic wire, a telephonic wire, a coaxial cable, a fiber optical cable, etc.). The system may also include an autonomous device for polling the tamper sensors periodically. The system may also include a low power system for transmission of tamper information using repeaters along the transmission line. The embodiments may thus assist in early detection, and targeted inspection and maintenance to prevent the disruptions in the distribution of power.

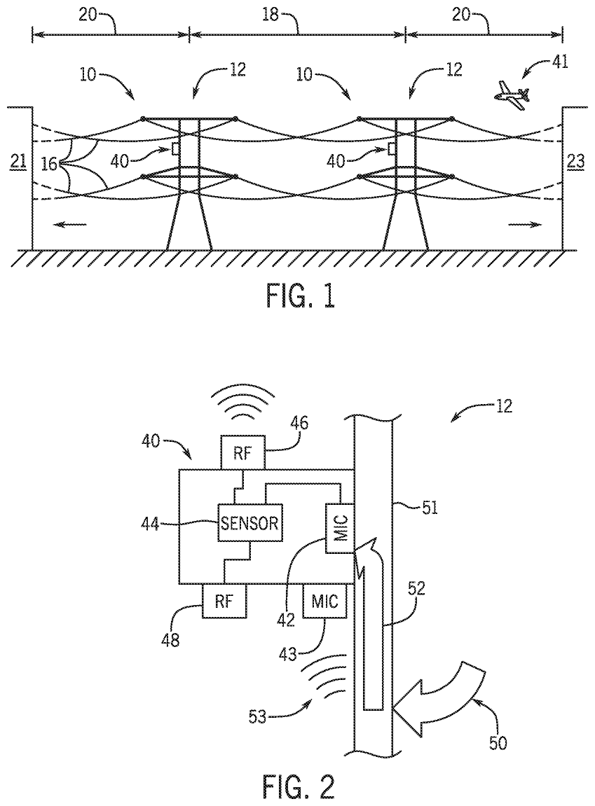

With the foregoing in mind, FIG. 1 illustrates a power transmission line 10 that may be monitored using an acoustic tamper detection system. The transmission line 10 may include several metallic structures 12, connected through power lines 16. The transmission line 10 may connect an electrical facility 21 (e.g., a power source, a power station, a consumer) to a second electrical facility 23. As illustrated, neighboring metallic structures 12 may be separated by a distance 18. Distance 18 may be relatively short (e.g., less than 100 yards, less than 300 yards, less than half-mile, less than one mile) as compared to distances between the electrical facilities 21 and 23. The illustrated metallic structures 12 may be at distances 20 and 22 from the electrical facilities 21 and 23, respectively. Electrical facilities 21 or 23 may be manned facilities. Distances 20 and 22 may be relatively long (e.g., tens of miles, hundreds of miles). Other metallic structures, which may be similar to the metallic structures 12, may cover distances 20 and 22. The metallic structures covering that distance may be separated by a relatively short distance similar to distance 18. As discussed below, distance 18 may be a distance that facilitates broadcasting of warning signals. The distances 20 and 22 may be large enough to make regular manual inspection of the illustrated metallic structures 12 less than desirable.

The metallic structures 12 may have tamper sensors 40 attached to them. The tamper sensors 40 may receive acoustic signals when an impact to the metallic structure 12 occurs. As discussed herein, the acoustic signals may refer to a vibration transmitted through the metallic structure 12 (i.e., sound waves through the physical medium) or a sound resulting from the impact the metallic structure 12 (i.e., sound waves through the air). Upon receiving an acoustic signal, the tamper sensor 40 may discriminate (e.g., filter) between a tamper sound and background noises, as detailed below.

In response to the tamper acoustic signal, the tamper sensor 40 may generate a warning. In some embodiments, the warning may be broadcast to an electrical facility (e.g., electrical facilities 21 or 23) directly and/or using repeaters, as detailed below. In some embodiments, the warning may be stored in the tamper sensor 40 and polled by autonomous polling devices. In the illustrated system, an unmanned aircraft 41 polls the tamper sensors 40. Other autonomous polling devices that may be used include transmission line crawlers (i.e., robots that can travel along the power lines 16 of the transmission line 10), self-driving land vehicles, and other systems capable of traversing the transmission line 10.

FIG. 2 illustrates a tamper sensor 40 connected to the metallic structure 12. The tamper sensor 40 may be directly coupled to a metallic beam 51 of the metallic structure 12, such that at least one side of the tamper sensor 40 is directly in touch with the metallic beam 51. As discussed above, a tamper attempt 50 may cause an acoustic signal 52 to travel within the metallic beam 51. To measure the acoustic signal 52, a contact microphone 42 of the tamper sensor 40 may be in direct contact with the metallic beam 51. In some embodiments, the contact microphone 42 may be formed from a piezoelectric material (e.g., a material with piezoelectric crystals) in direct contact with the metallic beam 51. In some embodiments, the contact microphone 42 may be formed using a condenser microphone design. In such system, a capacitor with a movable plate in direct contact with the metallic beam 51 may be used to generate electrical signals. Condenser microphones may be formed using micro-electrical mechanical systems (MEMS). Other systems, such as fiber-optic based systems or laser-based systems may be used to measure vibrations in the metallic beam 51. Other types of microphones, such as moving coil microphones or dynamic type microphones may be used to form the contact microphone 42.

In some embodiments, a second microphone 43 may be used in conjunction with the microphone 42. The microphone 43, may be used to measure acoustic waves 53 resulting from the tamper attempt 50. Microphone 43 may be any microphone capable of measuring sound signals from the air. The microphone 43 may receive sound inputs from several sources not necessarily related to tamper, such as weather conditions, traffic noise, or other ambient noises. The microphone 43 may also be used to detect potential human voices (e.g., voice of people responsible for the tamper attempt 50). Therefore, in some embodiments, the microphone 43 may be coupled to recording circuitry to facilitate identification the cause of the tamper attempt 50 or ambient conditions surrounding the tamper attempt 50. It should be noted that the sensor 40 may use one or more microphones 42 and/or 43 in conjunction, to improve the capacity to detect a tamper attempt 50 from a false positive.

The signals from microphones 42 and/or 43 may be transmitted to a sensor circuit 44 of the sensor 40. The sensor circuit 44 may use a filtering process to discriminate the acoustic signal 52 from background noise, and may use a threshold processing to identify a tamper signal, as detailed below. To that end, the sensor circuit 44 may be a digital circuit having signal processing capabilities, that implements a digital filter and a detector. In some embodiments, the sensor circuit 44 may be an analog circuit having an analog filter (e.g., a low pass filter, a high-pass filter, a band-pass filter, a filter bank) coupled to a comparator. In response to identifying the tamper signal, the sensor circuit 44 may generate a tamper warning signal. The tamper warning signal may be stored as tamper warning data in a memory of the sensor circuit 44, or the tamper warning signal may activate an electronic relay coupled to the sensor circuit 44.

The sensor 40 may include a radiofrequency circuit 46 to broadcast the alarm. In some embodiments, the radiofrequency circuit 46 may broadcast the tamper warning signal in response to the tamper warning signal generated by the sensor circuit 44. In some embodiments, the radiofrequency circuit 46 may poll periodically a memory or a relay in the sensor circuit 44 and broadcast the tamper warning signal in response to the presence of the tamper warning signal being activated. In some embodiments, the radiofrequency circuit 46 may periodically broadcast a status signal after polling the sensor circuit 44. In such embodiment, the radiofrequency circuit 46 broadcasts a normal status when no tamper warning signal is detected by the sensor circuit 44 and broadcasts the tamper warning signal when a tamper is detected by the sensor circuit 44. The radiofrequency circuit 46 may add identifying information in the broadcast signal. The identifying information may be an identifier of the specific metallic structure 12 that has the sensor 40. The identifying information may include a private key to prevent spoofing, which may be understood as an attempt to hack the tamper broadcast system using a false transmission from an unauthorized external device.

In some embodiments, the inspection of the metallic structures 12 may be performed by an autonomous device (e.g., the unmanned aircraft 41), as detailed below. In such system, the radiofrequency circuit 46 may be activated by a polling initiated in the unmanned aircraft 41. In response to the poll (e.g., a status request signal from the unmanned aircraft 41), the radiofrequency circuit 46 may search for a tamper warning signal broadcast by or indication of which in the sensor circuit 44 and transmit a status signal (e.g., tamper warning data or tamper warning flag) to the unmanned aircraft 41. In some embodiments, the radiofrequency circuit 46 may have a visual indicator that becomes active after the poll from the unmanned aircraft 41, and the unmanned aircraft 41 may identify the status by visual inspection (e.g., a computer vision system, transmission of the image to a home base). In some embodiments, a visual indicator (e.g., a light emitting diode (LED), a light bulb) may be used in place of the radiofrequency circuit 46. The visual indicator may be activated or modified when there is a tamper associated with the metallic structure 12 (e.g., tamper warning data or flag stored in the sensor).

In some embodiments, the broadcast from the radiofrequency circuit 46 may be transmitted using repeaters in neighboring sensors 40. A second radiofrequency circuit 48 may be used to implement the repeater functionality in the sensor 40. The second radiofrequency circuit 48 may include a receiver that receives a tamper warning signal from a neighboring device, validate the tamper warning signal in the sensor circuit 44, and propagate the tamper warning signal in the radiofrequency circuit 46. As detailed below, this manner of propagation of a broadcast signal may allow low power radiofrequency transmission from each sensor 40. In fact, in such system, each sensor 40 may generate broadcasts with low power to cover relatively short distances (e.g., distance 18) instead of large power broadcasts to cover longer distances (e.g., distance 20 or 22). In some embodiments, the first radiofrequency circuit 46 may implement the receive functionality and be used in place of the second radiofrequency circuit 48.

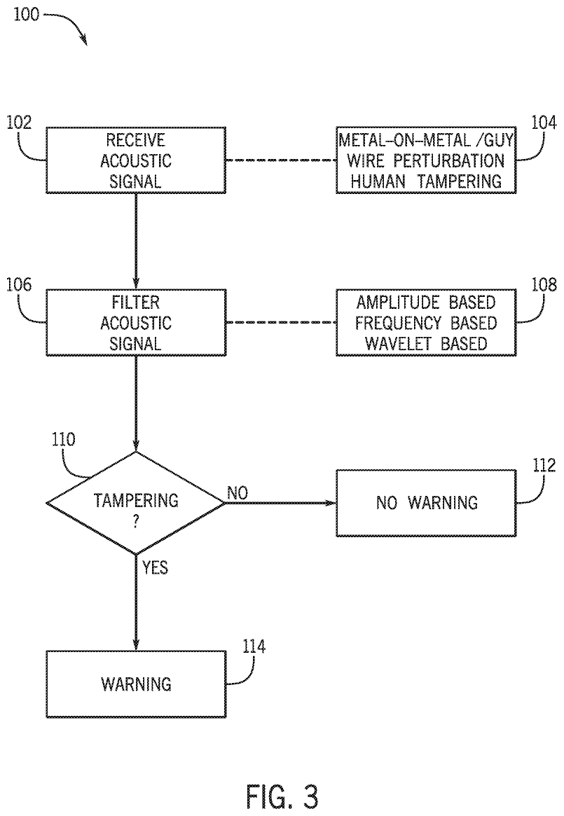

The flow chart in FIG. 3 illustrates a method 100 for operation of the sensor 40 in response to detecting a tamper attempt 50. In a process block 102, the sensor 40 may receive an acoustic signal (e.g., acoustic signal 52, acoustic waves 53). The acoustic signals may have origin in a perturbation 104 to a metallic structure (e.g., metallic structure 12) that may be associated with tampering. Examples of perturbations 104 include metal-on-metal noise (e.g., hammering or driving into the metallic structure, removal of beams from the metallic structure), guy wire perturbation (e.g., cutting the guy wire, removing the guy wire anchor), and/or human intervention (e.g., unauthorized person climbing on the structure). The acoustic signals receive may include background signals, such as weather related noise, seismic incidents, and/or traffic noise. These acoustic signals may be received by a contact microphone (e.g., contact microphone 42). It should be noted that the type of signals generated by the contact microphone, which captures metal borne sound waves (i.e., travelling through the structure), may be different from the ones generated by the microphone that captures air borne sound waves (i.e., travelling through the air). As such, a non-contact microphone (e.g., microphone 43) may be used in conjunction with the contact microphone 42 to detect tampering. As an example, the non-contact microphone may be capable of detecting human voices or ambient sounds (e.g., sounds of cars of trucks) that may be associated with the tamper attempt.

In a process block 106, the received acoustic signals may be filtered to discriminate background signals from potential signals. Metal-on-metal noise, guy wire noise, and/or human tampering may generate acoustic signals with a specific spectral signature. For example, the metal-on-metal noise may have an amplitude and/or frequency content in a specific region of the spectrum. Similarly, guy wire perturbations, a person climbing, and/or voices may have a specific amplitude and/or frequency content.

In general, the contact microphones may receive “clang” sounds as a result of tamper attempts. The clang sounds may be characterized as sounds with a sharp and sudden initial peak, driven by a metal-to-metal contact with a tool, and may be followed by sustained “ringing” vibrations that may have a frequency content that includes the resonant frequencies of the structure and the harmonics. The “ringing” vibrations may occur intermittently, presenting a beating pattern. As such, the sensor (e.g., sensor 40) may filter the incoming acoustic signal by amplifying components (e.g., frequency components, amplitude components, wavelet components) related to the type of perturbation, and by attenuating components of the acoustic signal unrelated to the type of perturbation. The filtering may employ a filter method 108. In some embodiments, the filter method 108 may be an amplitude-based filter (e.g., ignore signals with amplitude smaller than a threshold value). In some embodiments, the filter method 108 may be a frequency-based filter (e.g., implement a high-pass filter, a low-pass filter, a band-pass filter) to discard frequency content outside the frequencies of interest. A combination of amplitude-based and frequency-based filters may also be used. As an example, the filter may be employ an amplitude-based to measure an initial impact, and be followed by a frequency-based filter to measure sustained ringings.

In some embodiments, the filter may be designed based on previously acquired training data. That is, the identification of which components (e.g., frequency components, amplitude components, and/or wavelet components) should be amplified and/or rejected by the filter may be determined from previously acquired data. For example, wavelet-based filter banks may be designed by inspecting several acoustic signals of interest (e.g., acoustic signals generated by a particular type of perturbation) and identify the wavelet components associated with a mother wavelet or prototype wavelet that are more frequently associated with the type of perturbation.

The design of the filter may also be performed using artificial intelligence, machine learning, or any other statistical training technique. For example, filters, such as neural networks, finite impulse response (FIR) filters, infinite impulse response (IIR) filters, autoregressive (AR) filters, moving average (MA) filters, autoregressive moving average (ARMA) filters, and other discrete signal processing filters may be trained by identifying a set of coefficients that provides an improved discrimination capacity in the training data. In some embodiments, filter banks that implement the above-described strategies may also be produced using analog circuitry (e.g., RLC filters, operational amplifier feedback filters).

In the decision block 110, the filtered signal may be compared with a threshold or profile. If the filtered signal does not exceed the threshold or does not conform with a profile, no tamper warning signal is generated (process block 112). Otherwise, if the filtered signal exceeds the threshold or conforms with a profile, the tamper warning signal is generated (process block 114). The filtered signal may be converted to a signal power, a time integration of the signal over a pre-defined period, the principal frequency component of the signal, or any other conversion prior to comparison with the threshold or profile. When the tamper warning signal is generated in process block 114, a memory cell (e.g., a capacitor, a flip-flop) or a relay may be triggered to store tamper warning data that records an indication of the presence or the detection of the tamper warning. and respond to a polling request, as discussed above. In some embodiments, the memory tamper warning data may include transmitted and/or broadcasted may include information related to the acoustic signal or the filtered signal, such as a recording of the audio captured by the microphone, a recording of the filtered signal, a compressed recording of the filtered signal, a timestamp associated with the moment of the event, and/or a classification parameter that indicates the type of filtering that was detected. The tamper warning signal may additionally, or alternatively trigger a broadcast of the tamper warning signal or the tamper warning data through the RF circuitry, as discussed above.

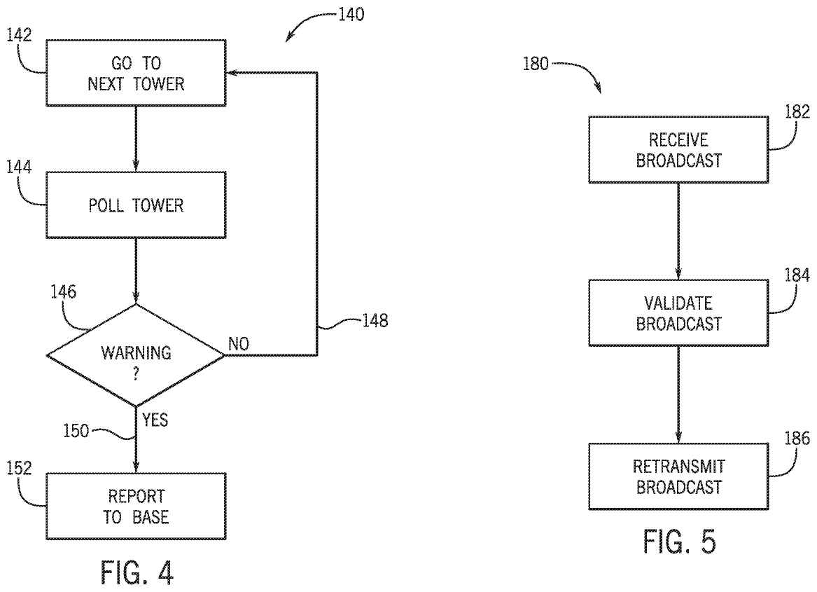

FIG. 4 illustrates a method 140 for monitoring of metallic structures (e.g., metallic structures 12) in a transmission line (e.g., transmission line 10). The method 140 may be performed by an autonomous vehicle, such as unmanned aircraft 41, a drone, a transmission line crawler, a self-driving car, or any other robot capable of traversing the metallic structures of a transmission lines. In process block 142, the unmanned aircraft 41 may travel to a metallic structure. Upon arriving at the metallic structure, in process block 144, the autonomous vehicle may poll the acoustic sensor (e.g., sensor 40). Polling of the acoustic sensor may involve sending a status request signal and waiting for a response signal. The response signal may be a radiofrequency signal and/or a visual signal, as discussed above. In some embodiments, the acoustic sensor may periodically emit a status signal. In such situation, polling of the acoustic sensor may involve waiting for the periodic status signal.

Upon receiving the status signal from the acoustic sensor, the autonomous vehicle may determine whether the status signal contains tamper warning data, in decision block 146. In some embodiments, the inspection of the status signal in decision block 146 may include a validation step, in which an identifier or a private key is inspected and/or verified. For example, the status signal may be encoded using a private key to encrypt the transmitted message. Additionally, or alternatively, the status signal may contain an identifier associated with the metallic structure and the autonomous vehicle may validate the status signal by checking if the metallic structure associated with the identifier is in the correct location (e.g., the correct global positioning system (GPS) location).

If no warning signal was identified (branch 148), the autonomous vehicle may proceed to the next metallic structure in process block 142. If a tamper warning signal was identified (branch 150), the autonomous vehicle may return to a home base to report the tamper warning data, in process 152. In some embodiments, the absence of any response from the sensor may be interpreted as a presence of a tamper warning signal. The home base may be a manned power station or facility, an unmanned power station or facility with telecommunication capabilities, or any other place capable of receiving the data from the unmanned vehicle to warn an operator. In some embodiments, the home base may be capable of automatic adjustment of the usage of the metallic structure identified as potentially tampered. For example, the home base may be a power grid management facility that may reduce or remove the electrical transmission through a metallic structure identified as potentially tampered.

FIG. 5 illustrates a method 180 for propagation of tamper warning signals along repeaters or acoustic sensors in the transmission line (e.g., transmission line 10). The method 180 may be implemented using the acoustic sensors (e.g., sensor 40) attached to metallic structures (e.g., metallic structure 12) and capable of performing repeater functionalities, as discussed above. The method 180 may also employ dedicated repeaters. As discussed above, the placement of acoustic sensors and repeaters separated at relatively small distances (e.g., distance 18 in FIG. 1) allow the use of reduced power for the propagation of signals. The method 180 may be performed by the acoustic sensors with repeater functionality and/or repeaters. In process block 182, the acoustic sensor may receive the broadcast signal from a neighboring repeater or acoustic sensor. In process block 184, the acoustic sensor and/or repeater may validate the broadcast. Validation of the broadcast may take place by inspection an identifier or verifying the use of a private key for encryption. In process block 186, the acoustic sensor and/or repeater may retransmit the validated tamper warning data.

In some embodiments, validation of the tamper warning data in process 184 may include a mechanism to prevent multiple retransmissions of a message. For example, the acoustic sensor and/or repeater may have a memory or buffer that stores the identifier associated with previously sent warning data. In the process block 184, the identifier may be compared with the stored identifiers, prior to retransmission. If the identifier is associated with a previously sent message, the message is not retransmitted in process 186.

The embodiments set forth in the present disclosure may be susceptible to various modifications and alternative forms, specific embodiments have been shown by way of example in the drawings and have been described in detail herein. However, it may be understood that the disclosure is not intended to be limited to the particular forms disclosed. The disclosure is to cover all modifications, equivalents, and alternatives falling within the spirit and scope of the disclosure as defined by the following appended claims. In addition, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). For any claims containing elements designated in any other manner, however, it is intended that such elements are not to be interpreted under 35 U.S.C. 112(f).

1. An acoustic sensor for a metallic structure, comprising:
a contact microphone configured to be placed in direct contact with the metallic structure;
filtering and discrimination circuitry configured to receive a signal from the contact microphone, filter the received signal, and generate a warning signal based on the filtered signal, wherein the filtering circuitry is configured to amplify one or more components of the signal to permit detection of a perturbation to the metallic structure; and
radiofrequency circuitry configured to transmit a radiofrequency signal based on the warning signal to a repeater, another acoustic sensor positioned on another metallic structure, or an electrical facility.

2. The acoustic sensor of claim 1, wherein the contact microphone comprises a piezoelectric microphone, a condenser microphone, or a moving-coil microphone, or any combination thereof.

3. The acoustic sensor of claim 1, wherein the filtering and discriminating circuitry comprises a digital signal processor.

4. The acoustic sensor of claim 1, wherein the filtering and discriminating circuitry is configured detect a first feature of interest associated with the perturbation to the metallic structure by using an infinite impulse response, a finite impulse response filter, an autoregressive filter, a moving average filter, an autoregressive moving average filter, or any combination thereof.

5. The acoustic sensor of claim 1, wherein the filtering circuitry comprises a high-pass filter, a low-pass filter, or a band-pass filter.

6. The acoustic sensor of claim 1, wherein the filtering circuitry comprises a filter bank associated with one or more wavelet components associated with a mother wavelet.

7. The acoustic sensor of claim 1, wherein the perturbation comprises a metal-on-metal perturbation, a guy wire perturbation, or a human intervention perturbation.

8. The acoustic sensor of claim 1, comprising a second microphone configured to receive air borne sound waves generated by the perturbation.

9. The acoustic sensor of claim 8, wherein the filtering circuitry is configured to receive a second signal from the second microphone, and to generate the warning signal based on the filtered signal and the second received signal.

10. The acoustic sensor of claim 1, wherein the radiofrequency circuitry is configured to receive a second radiofrequency signal from a second acoustic sensor and retransmit the second radiofrequency signal to the repeater, the acoustic sensor, or the electrical facility.

11. A transmission line system, comprising:
a metallic structure; and
an acoustic sensor directly attached to the metallic structure, wherein the acoustic sensor is configured to receive an acoustic signal and detect one or more components of the acoustic signal not associated with a perturbation to the metallic structure that indicates physical tampering with the metallic structure.

12. The transmission line system of claim 11, wherein the acoustic sensor comprises a radiofrequency transmitter configured to transmit a radiofrequency warning signal at a power that covers a first distance between the acoustic sensor and an autonomous vehicle, a second acoustic sensor directly attached to a second metallic structure of the transmission line system, a repeater of the transmission line system, or an electrical facility adjacent to the transmission line system, and wherein the first distance is less than 1 mile.

13. The transmission line system of claim 12, wherein the radiofrequency transmitter is configured to broadcast the radiofrequency warning signal to the second acoustic sensor, and the second acoustic sensor comprises a radiofrequency receiver configured to receive the radiofrequency warning signal and broadcast the radiofrequency warning signal to a third acoustic sensor, a second repeater, or a second electrical facility.

14. The transmission line system of claim 11, wherein the acoustic sensor comprises a contact microphone configured to be placed in direct contact with the metallic structure, wherein the contact microphone comprises a piezoelectric microphone, a condenser microphone, or a combination thereof.

15. The transmission line system of claim 11, wherein the acoustic sensor is configured to attenuate one or more components of the acoustic signal not associated with the perturbation to the metallic structure and wherein the one or more components of the received acoustic signal associated with the perturbation comprise one or more frequency components, one or more amplitude components, one or more wavelet components, or a combination thereof.

16. The transmission line system of claim 11, wherein each respective acoustic sensor comprises a respective memory configured to store warning data based on a warning signal from the acoustic sensor, and wherein the acoustic sensor is configured to broadcast the warning data to an autonomous vehicle upon a polling request from the autonomous vehicle.

17. A method to monitor a transmission line system, comprising:
detecting, via a processor, a tamper to a metallic structure of a plurality of metallic structures of the transmission line system using an acoustic sensor that comprises a contact microphone in direct contact with the metallic structure; and
sending, via the processor, a tamper warning signal in response to detecting the tamper.

18. The method of claim 17, wherein sending the tamper warning signal comprises sending the tamper warning signal an autonomous polling device based on the detection of the tampering, and wherein the autonomous polling device is configured to report the tamper at a home base.

19. The method of claim 18, wherein the autonomous polling device comprises an unmanned aircraft, a transmission line crawler, or a self-driving vehicle.

20. The method of claim 17, wherein the tamper comprises a metal-to-metal collision, a guy wire perturbation, or human intervention.
